(19) United States
(12) Patent Application Publication
(10) Pub. No.: US 2009/0187781 A1
(43) Pub. Date: Jul. 23, 2009

(54) Electronic Control Unit with Power Loss Compensation

(75) Inventors: Frank Gronemeier, Bonen (DE); Markus Ferber, Warstein (DE); Christian Franck, Erwitte (DE); Jesko Ehrich, Lippstadt (DE)

Correspondence Address: HUSCH BLACKWELL SANDERS LLP, 190 CARONDELET PLAZA, SUITE 600, ST. LOUIS, MO, 63105-3441, US

(73) Assignee: Hella KG Hueck & Co., Lippstadt (DE)

(21) Appl. No.: 12/018,428

(22) Filed: Jan. 23, 2008

(51) Int. Cl. G06F 1/28

(52) U.S. Cl. 713/340

(57) ABSTRACT

In accordance with the described embodiments vehicular electronic control units and their operating methods are described which cost effectively compensate momentary external power loss by reducing the unit's power consumption while external power is lost. In an exemplary embodiment external power loss is detected by the electronic control unit's microprocessor. The microprocessor thereupon disables some components within the electronic control unit and operates with limited functionality for the duration of external power loss. The electronic control unit uses internal energy storage, e.g. a hold capacitor, to sustain its limited functionality operation. Upon recovery from the external power loss the electronic control unit resumes full operation.

### BACKGROUND OF THE INVENTION

1. Field of the Invention

The present invention generally relates to electronic control units and, and more particularly, to vehicular electronic control units with power loss compensation.

2. Background of the Invention

Automobiles are increasingly using electronic control units (ECUs) to control vehicle equipment based on sensor data. A forward looking camera may, for example, detect preceding and oncoming traffic and control the vehicle's headlights in response thereto. More specifically, the camera may automatically control high headlights beams to turn on only if no other vehicles will be subjected to undue glare. A camera may also detect lane markings and warn the driver in case of accidental lane departures. A radar sensor may alert the driver to objects in the driver's blind spot.

The increasing sophistication of vehicle features requires calculating complex algorithms and/or processing large amounts of sensor data. Especially driver assistance systems employing radar sensors or vision sensors have to process large amounts of raw sensor data, and possibly combine data from several sensors to control vehicle equipment. This requires electronic processors capable of computing intensive tasks in real time, which causes increased processor power consumption.

Electronic control units may include two or more electronic processors. Such multi-processor architectures are common in vehicular driver assistance systems, e.g. camera, radar or lidar systems. In multi-processor configurations one processor may be a microprocessor dedicated to interfacing with the vehicle while other electronic processors, e.g. digital signal processors or programmable gate arrays, may be used for computing intensive tasks such as image processing or the analysis of radar echoes.

A problem in vehicles is that large electric consumers, e.g. steering motors, can cause momentary vehicle battery voltage drops. This subjects electronic control units to short periods of total or partial power loss. Momentary power loss is often considered unavoidable by the vehicle manufacturer, and has to be compensated by electronic control units to avoid vehicle equipment malfunction. Vehicle manufacturers often require microprocessors in electronic control units to not reset during momentary power loss up to a specified duration, typically between 10 and 100 milliseconds. A microprocessor reset must be avoided, since it would cause the electronic control unit to enter a default state upon recovery from the power loss. This could lead to vehicle equipment being temporarily switched on/off during a power loss induced microprocessor reset. For example, an automatically activated high beam headlight might be temporarily switched off during a reset and back on after the microprocessor recovers from its reset. This may cause undesirable flickering and must be avoided.

Traditional power supplies in electronic control units include hold capacitors as energy storage devices to compensate for momentary external power loss. During momentary drops of the external supply voltage the power supply inside the electronic control unit maintains a constant voltage to the microprocessor and other components by discharging the hold capacitor. The hold capacitor is dimensioned such that the electronic control unit can survive battery power loss up to the anticipated maximum duration, typically between 10 and 100 milliseconds, without microprocessor reset.

The conventional approach of using a hold capacitor sufficiently large enough to keep the electronic control unit operational during momentary battery power loss is, however, limited when it comes to control units with high power demand. One disadvantage with the conventional approach is the increase in cost to provide sufficient capacitance for the entire unit to operate during periods of external power loss. Another is the relatively large size of capacitors with sufficient capacitance. Size is of particular concern, if the electronic control unit is mounted in a visible location, as is the case e.g. with a front camera mounted to the vehicle's windshield.

Therefore, in light of the problems associated with existing approaches, there is a need for improved electronic control units that can compensate momentary supply power loss without the cost and size increase associated with large hold capacitors.

### SUMMARY OF THE INVENTION

In accordance with the described embodiments vehicular electronic control units and their operating methods are described. In an exemplary embodiment the electronic control unit reduces its power consumption during periods of external power loss. External power loss is detected by the electronic control unit's electronic processor utilizing a low voltage detection circuit. The electronic processor thereupon disables one or more components within the electronic control unit so that the electronic control unit operates with limited functionality for the duration of external power loss. The electronic control unit uses internal energy storage, e.g. a hold capacitor, to sustain its limited functionality operation during the momentary external power loss. Upon recovery from the external power loss the electronic control unit resumes full operation.

In another exemplary embodiment the electronic control unit comprises two or more electronic processors, which are communicating with each other. A first processor interfaces with external vehicle equipment, e.g. the vehicle headlamps, an electric blower motor, a relay, or visual, audible, or tactile driver warning equipment. The first electronic processor may control the vehicle equipment directly, e.g. by changing the state of one of its outputs, or indirectly, e.g. by sending a message through a serial communication system to another electronic control unit. A second electronic processor performs computing intensive tasks, e.g. analyzing the video stream from an image sensor or analyzing the echo data from a radar receiver. During normal full operation the first electronic processor controls the state of the vehicle equipment in response to information processed by the second electronic processor.

Both electronic processors are powered by an internal power supply, which is connected to the vehicle battery. Vehicle battery voltage is monitored by a low voltage detection circuit. If the vehicle battery voltage falls below a predetermined value a low-voltage signal is generated. The internal power supply comprises a hold capacitor, which is discharged during external power loss. To maximize the time that can be compensated by the limited energy stored in the hold capacitor, the electronic control unit's power consumption is reduced during external power loss. Power consumption is reduced by switching the second processor into a low current consumption state, such as by turning off the second processor's supply voltage, reducing the second processor's operating frequency, or ordering the second processor into a sleep, deep sleep, or hibernation mode.

Abruptly turning off the second processor's supply voltage may cause undesirable memory loss, and should be avoided. Therefore the second processor may be turned off with a delay after a low-voltage condition is detected. The low-voltage signal is communicated to the second processor, which responsive thereto prepares for an imminent power loss by saving settings into keep-alive memory. Power to the second processor may be removed with a predetermined delay time sufficiently long for the second processor to save its settings. Alternatively, the second processor may signal that it is ready to shut down.

While the second processor is in low power consumption mode it no longer performs its computing intensive tasks, and communication with the first processor may be lost. The electronic control unit operates in limited function mode. The first processor maintains the vehicle equipment state unchanged while the second processor is unavailable. Once the external battery voltage recovers the second processor resumes normal operation. The first processor may once again update the state of the vehicle equipment based on information provided by the second microprocessor.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is a block diagram of an exemplary electronic control module with external power loss compensation.

FIG. 2 is a block diagram of another exemplary electronic control module that is suitable for use in connection with the described embodiments.

FIG. 3 is a graph that is useful in understanding the operating environment of the described embodiments.

FIG. 4 is a flow diagram that describes steps in a method in accordance with one of the described embodiments.

FIG. 5 is a flow diagram expanding on the method illustrated in FIG. 4 and describes steps in a method in accordance with one of the described embodiments.

### DETAILED DESCRIPTION

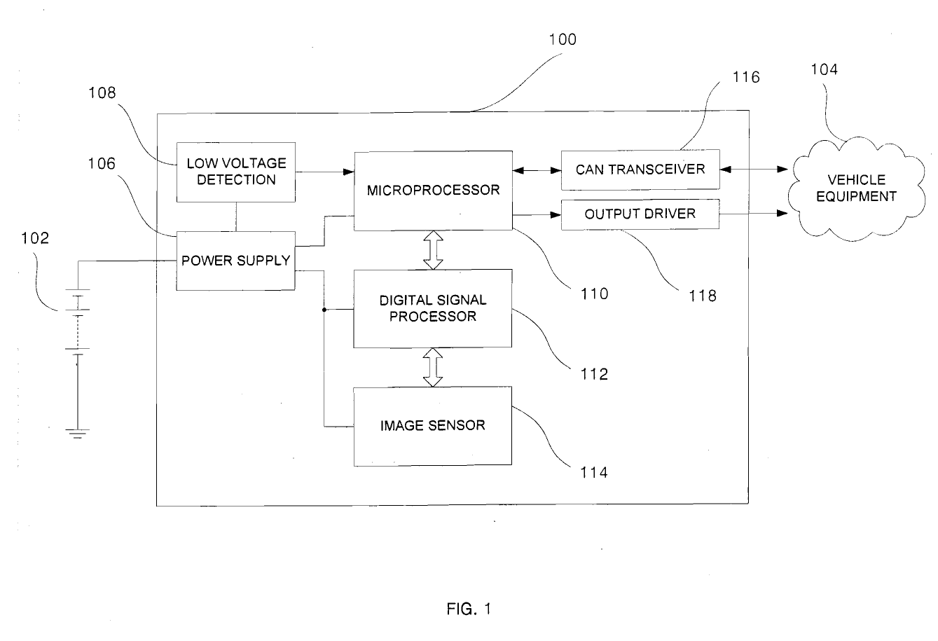

Referring to FIG. 1, a block diagram of an exemplary electronic control unit 100 in which the principles of the present invention may be advantageously practiced is illustrated generally. Electronic control unit 100 illustrates building blocks of a forward looking automotive camera. The camera may e.g. be used as part of a Lane Departure Warning System, a High Beam Control System and/or an Object Detection and classification System. Electronic control unit 100 includes an image sensor 114, which is operatively connected to digital signal processor 112. A stream of digital video is transmitted from image sensor 114 to digital signal processor 112. Image sensor control information is sent in the opposite direction from digital signal processor 112 to image sensor 114. Digital signal processor 112 analyzes the video stream provided by image sensor 114 and derives the desired vehicle feature, e.g. a decision to warn the driver of an accidental lane departure, or a decision to turn on high-beam headlights.

The interface between electronic control unit 100 and vehicle equipment 104, e.g. the headlamps or a warning device, is controlled by microprocessor 110. During normal operation microprocessor 110 communicates with digital signal processor 112 and determines the desired state of vehicle equipment 104 based on the result of the sensor information processed by digital signal processor 112. Microprocessor 110 may control external vehicle equipment 104 directly by selecting the state of output driver 118, or indirectly by communicating with other electronic control units connected to a serial data communication system, here illustrated by CAN transceiver 116.

Power to all components in electronic control unit 100 is provided by power supply 106, which is connected to vehicle battery 102. Power supply 106 comprises an electric energy storage component, e.g. a hold capacitor or a backup battery. During momentary external power loss the electric energy storage component is discharged in order to keep electronic control unit 100 operational with a least limited functionality. To maintain limited functionality supply 106 maintains a constant internal supply voltage to at least microprocessor 110, CAN transceiver 116 and output driver 118 in the depicted embodiment. Keeping those components powered enables electronic control unit 100 to maintain the current state of any vehicle equipment 104 that is controlled through either CAN messages or direct outputs through momentary external power losses.

External battery voltage VBAT is monitored through battery voltage monitoring circuit 108 by microprocessor 110. In case of a low external battery voltage microprocessor 110 switches digital signal processor 112 into a low power mode. Reducing the power consumption in digital signal processor 112 causes the internal energy storage component inside power supply 106 to be discharged at a slower rate. This extends the time without external power that can be compensated without causing microprocessor 110 to reset. For automotive applications external power loss lasting up to between 10 and 100 milliseconds must typically be sustained without affecting the interface between electronic control unit 100 and other vehicle equipment 104.

While a specific example has been shown in FIG. 1 it will be appreciated that many equivalent alternatives for each component exist. Controller area network (CAN) interface 116 may for example be any other data communication interface, among them LIN, Class 2, MOST, USB, Firewire, and Flexray. Microprocessor 110 and Digital Signal Processor 112 may be any other electronic processor, among them microprocessor, microcontroller, flexible programmable gate array or application specific integrated circuit. Image sensor 114 may be any form of electronic sensor, e.g. a radar sensor, ultrasonic sensor, radio frequency receiver, inertia sensor, or lidar sensor.

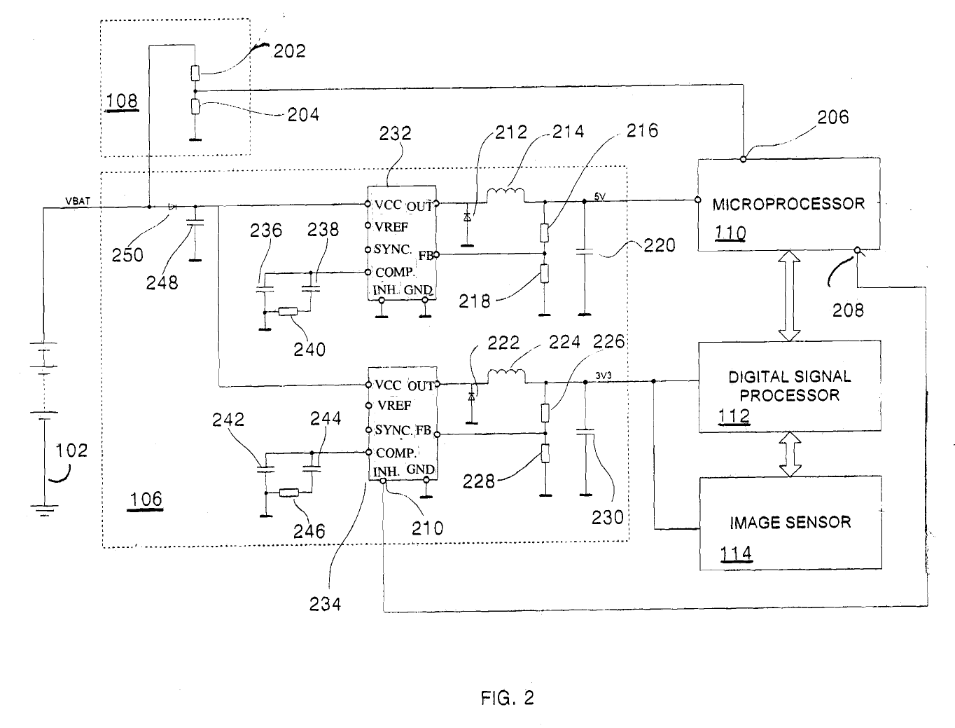

FIG. 2 further illustrates an exemplary electronic control unit in accordance with one embodiment of the invention. Here, microprocessor 110 is powered by a 5V regulated voltage which is provided by power supply 106. Digital signal processor 112 and image sensor 114 are powered by 3.3V regulated voltage provided by power supply 106. Power supply 106 comprises two step-down converters 232, 234 to generate the internal 5V and 3.3V supply voltages. The step-down converters may for example be commonly used L5973 type step down monolithic power converters manufactured by ST microelectronics. The output voltage of converter 232 is filtered using the low pass characteristics of inductor 214 and capacitor 220. Diode 212 servers as a free-wheeling diode when the output of converter 232 is switched off. Resistors 216 and 218 form a voltage divider to establish the required feedback voltage to regulate converter 232. Similarly the output voltage of converter 234 is filtered using the low pass characteristics of inductor 224 and capacitor 230. Diode 222 servers as a free-wheeling diode when the output of converter 234 is switched off. Resistors 226 and 228 serve as a voltage divider, providing the required feedback voltage to regulate converter 234. Capacitors 236, 238 and resistor 240 provide a compensation circuit and are connected to the error amplifier output of converter 232. Capacitors 242,244 and resistor 246 serve the same purpose at converter 234. Converters 232,234 are connected to the vehicle battery 102 through a low battery voltage protection diode 250.

Battery voltage VBAT is monitored using low voltage detection circuit 108. Low voltage is detected by dividing VBAT through voltage divider resistors 202,204 which are connected to analog input 206 of microprocessor 110. Digital output 208 of microprocessor 110 is connected to inhibit input 210 of converter 234. If low battery voltage VBAT is detected microprocessor 110 can set its output 208 to high, causing converter 234 to turn off the 3.3V supply to digital signal processor 112 and image sensor 114.

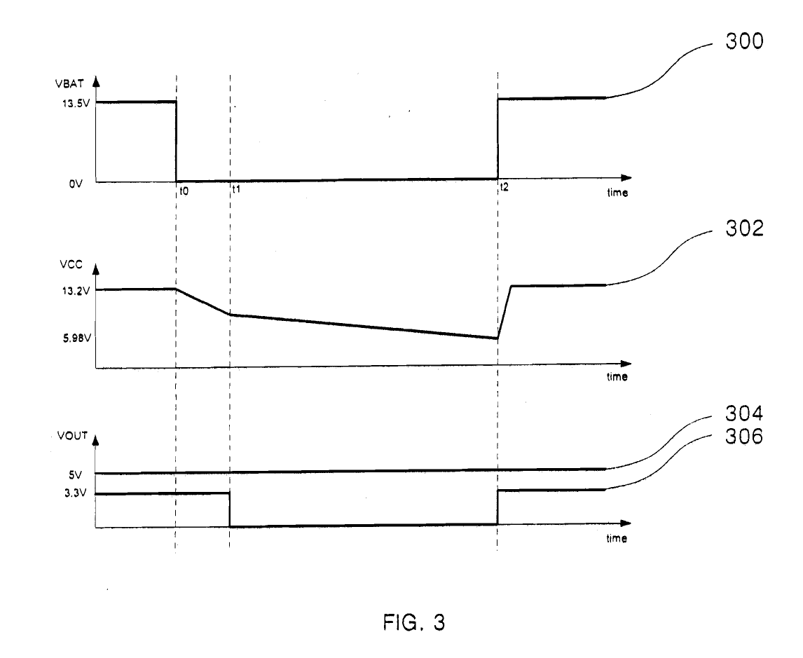

FIG. 3 illustrates characteristic voltage curves that may be experienced in the circuit illustrated in FIG. 2. During normal driving conditions before time t0 vehicle battery voltage VBAT, represented by line 300, is around 13.5 Volts. VCC, the voltage at regulators 232, 234 and hold capacitor 248, is around 13.2 V, corresponding to a 0.3 Volt drop over low battery protection diode 250. VCC is illustrated by line 302. Regulator 232 generates a constant 5V output illustrated by line 304, regulator 234 a constant 3.3V output illustrated by line 306.

Activation of large electric consumers in the vehicle, e.g. large electric motors such as electric steering actuators, may momentarily cause battery voltage VBAT to drop below its nominal value. This is illustrated in FIG. 3 by a drop of VBAT to 0 Volt beginning at time t0. After t0 voltage VCC at hold capacitor 248 is higher than VBAT, which causes diode 250 to block. Regulators 232,234 are effectively decoupled from vehicle battery 102 and powered from the energy stored in hold capacitor 248. This causes hold capacitor 248 to be rapidly discharged, as illustrated by a fast decline in VCC between t0 and t1 in curve 302. The low battery voltage condition is sensed by microprocessor 110 through its analog input 206, which is connected to voltage divider resistors 202, 204.

After a low battery voltage occurs at time t0 microprocessor 110 communicates the low voltage condition to signal processor 112. Signal processor 112 prepares for an imminent power loss by saving critical data to memory not affected by a loss of the 3.3V supply voltage. This may for example be EEPROM or Flash memory, RAM memory not powered by the 3.3V power supply, or memory within microprocessor 110. After all critical memory is saved, digital signal processor 112 communicates its readiness for shutdown to microprocessor 110.

At time t1, responsive to receiving a shutdown readiness notice from digital signal processor 112, microprocessor 110 turns its digital output 208 to high, causing inhibit input 210 at converter 234 to go high, which turns converter 234 off. Curve 306 illustrates the 3.3V output of converter 234 going to zero as converter 234 is turned off at time t1. With digital signal processor 112 and image sensor 114 being powerless after t1 the overall power consumption in the electronic control unit is substantially decreased. Therefore hold capacitor 248 is discharged at a slower rate, shown by a slower gradient of VCC between t1 and t2 in line 302. The slower discharge rate allows regulator 232 to maintain a constant output voltage up to t2, at which point VCC reaches about 5.98 Volts, the minimum input voltage required to generate a constant 5V output.

As illustrated VBAT recovers after t2, which allows the electronic control unit to resume normal operation and reactivate the 3.3V power supply 234 to digital signal processor 112 and image sensor 114.

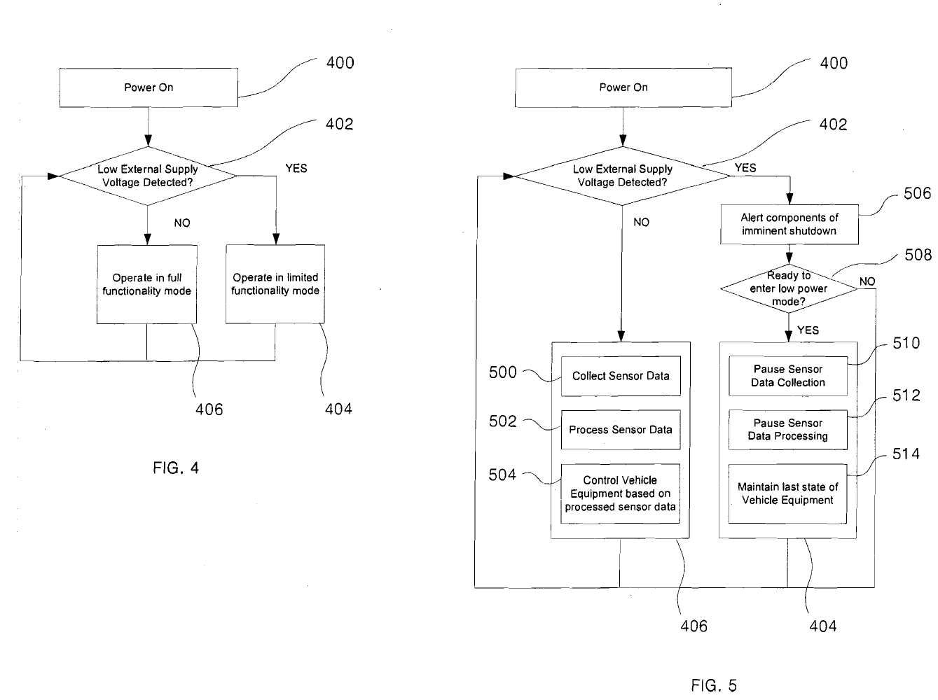

FIG. 4 is a flow chart illustrating an exemplary method of operating an electronic control unit during momentary power loss. The electronic control unit after powering up in step 400 periodically monitors external battery voltage. If in step 402 external battery voltage is found to be sufficiently high the electronic control unit operates in full functionality mode 406. If in step 402 a low external battery voltage is detected the electronic control unit operates in limited functionality mode 404 with reduced power consumption.

FIG. 5 is a more detailed flow chart expanding on the method of FIG. 4. The method illustrated in FIG. 5 is applicable for example for automotive sensor electronic control units such as a forward looking cameras or radar sensors. After power on step 400 the electronic control unit cyclically monitors for low voltage conditions. If in step 402 a sufficiently high external supply voltage is detected the electronic control unit operates in full functionality mode 406. Full functionality comprises collecting sensor data step 500, processing sensor data step 502 and controlling vehicle equipment based on the processed sensor data step 504.

If low external supply voltage is detected in step 402 the electronic control unit prepares to reduce its power consumption. Components that can not be abruptly disabled are informed about an imminent power loss in step 506. Once it is determined in step 508 that the unit is ready to enter low power mode, i.e. affected components have indicated their readiness to shut down or enter a sleep mode, the electronic control unit enters limited functionality mode 404. In limited functionality mode sensor data collection step 510 may be paused, e.g. by removing power from a sensor component, e.g. an image sensor or radar transceiver. Correspondingly sensor data processing step 512 is paused, e.g. by removing power from a digital signal processor or switching a digital signal processor into sleep mode. The interface between electronic control unit and external vehicle equipment in step 514 is no longer updated.

The effect of operating the electronic control unit in limited functionality mode 404, especially maintaining the last know state of vehicle equipment in step 514, may take various forms, depending on the vehicle function controlled by the electronic control unit. An automatic high beam control system may e.g. maintain the state of high beam activation in lieu of new sensor data, i.e. not react to new vehicles or vehicles leaving the field of view of the camera during momentary power losses. A lane departure warning system may not issue new warnings when crossing a lane marking, but may choose to let warnings issued before entering limited functionality mode 404 expire based on a predetermined latency. In this case maintaining the last state of vehicle equipment step 404 consists of not preventing the default expiration of a warning and turning off e.g. a warning light, buzzer or vibration actuator.

The methods illustrated in FIG. 4 and FIG. 5 may be executed cyclically, e.g. by reading and evaluating external voltage in an A/D converter in microprocessor 110 in a fixed cycle time. Since the power consumption in the electronic control unit has to be reduced very quickly after a loss of external power, typically within less than a few milliseconds, the cycle time for monitoring external power supply voltage has to be very fast, e.g. at least once every millisecond. Such fast cycle times may be incompatible with the software architecture in microprocessor 110, which may be designed around cycle times around 20-100 milliseconds. An alternative embodiment may overcome this limitation by utilizing a low voltage detection circuit with digital output, that is connected by an external interrupt input to microprocessor 110. The low voltage detection circuit is designed to cause a processor interrupt when the external battery supply voltage falls below a predetermined value, e.g. around 9 Volts. Microprocessor 110 can therefore detect low external voltage without cycle time dependent latency.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. An electronic control unit comprising:
a power supply with an electric energy storage component,
a battery voltage monitoring circuit,
a first electronic processor adapted to interface with a vehicle equipment element,
a second electronic processor, the first and the second microprocessors, the electric energy storage component and the monitoring circuit all being in operative communication,
wherein:
the second electronic processor enters a mode with a reduced power consumption when battery voltage falls below a predetermined value, and
the first processor maintains control of the vehicle equipment while the second processor is in reduced power mode.

2. The electronic control unit of claim 1, wherein the electric energy storage component is a capacitor.

3. The electronic control unit of claim 1, wherein the electric energy storage component holds sufficient energy to keep the first processor operational for approximately 10 to 100 milliseconds after a loss of battery power to the electronic control unit.

4. The electronic control unit of claim 1, wherein the second electronic processor enters the mode with reduced power consumption after it has saved settings into a memory that is maintained during the reduced power consumption mode.

5. The electronic control unit of claim 1, wherein the power supply generates a plurality of internal voltages and at least one internal voltage is switched off while the electronic control unit operates in a mode with reduced power consumption.

6. The electronic control unit of claim 1, wherein the battery voltage monitoring circuit is operatively connected to the first or the second electronic processor and the processor input to which the voltage monitoring circuit is connected is an analog-to-digital converter input or an external interrupt input.

7. The electronic control unit of claim 1 wherein the vehicle equipment is selected from the group consisting of a headlamp, a tail lamp, an interior light, a warning device, an information display, a blower motor, and a windshield wiper.

8. The electronic control unit of claim 1 further comprising an external vehicle equipment interface selected from the group consisting of: a low side driver, a high side driver, a pulse width modulated signal, and a serial data message.

9. The electronic control unit of claim 1 wherein a detection of a low battery supply voltage is performed in an electronic processor by periodically sampling the supply voltage in an analog to digital converter.

10. The electronic control unit of claim 1 wherein a detection of a low battery supply voltage is performed by generating an external interrupt signal to an electronic processor if the supply voltage falls below a predetermined value.

11. The electronic control unit of claim 1 wherein the second processor processes data signals from a sensor.

12. The electronic control unit of claim 1 wherein the sensor is selected from the group consisting of: a vision sensor, a lidar sensor, a radar sensor, and an ultrasonic sensor.

13. A method for operating an electronic control unit with external equipment interface during momentary power loss comprising the steps of:
detecting low battery supply voltage;
selectively disabling components within the electronic control unit; and
maintaining unchanged the state of vehicle equipment controlled by the electronic control unit.

14. The method according to claim 13 wherein the vehicle equipment is selected from the group consisting of a headlamp, a tail lamp, an interior light, a warning device, an information display, a blower motor, and a windshield wiper.

15. The method according to claim 13 wherein the external vehicle equipment interface is selected from the group consisting of a low side driver, a high side driver, a pulse width modulated signal, and a serial data message.

16. The method according to claim 13 wherein the step of detecting low battery supply voltage is performed in an electronic processor by periodically sampling the supply voltage in an analog to digital converter.

17. The method according to claim 13 wherein the step of detecting low battery supply voltage is performed by generating an external interrupt signal to an electronic processor if the supply voltage falls below a predetermined value.

18. An automotive electronic control unit for processing sensor data and controlling vehicle equipment as a function of the processed sensor data from a sensor comprising:
a normal operating mode and a limited function operating mode wherein:
the limited function operating mode is activated if a supply voltage falls below a predetermined value;
processing of the sensor data is suspended while the control unit is operating in the limited function operating mode; and
processing of the sensor data resumes when the control unit is in the normal operating mode.

19. The control unit of claim 18 wherein the sensor is selected from the group consisting of a vision sensor, a lidar sensor, a radar sensor, and an ultrasonic sensor.

20. The control unit of claim 18 wherein a state of vehicle equipment controlled by the electronic control unit is maintained unchanged while the electronic control unit is operating in the limited functionality mode.
